(19) United States
(12) Patent Application Publication
(10) Pub. No.: US 2025/0292535 A1
(43) Pub. Date: Sep. 18, 2025

(54) INFORMATION PROCESSING APPARATUS AND DETECTION METHOD

(71) Applicant: KABUSHIKI KAISHA TOSHIBA, Tokyo (JP)

(72) Inventors: Hiroaki TANI, Kawasaki Kanagawa (JP); Yuta SHIRAKAWA, Komae Tokyo (JP)

(73) Assignee: KABUSHIKI KAISHA TOSHIBA, Tokyo (JP)

(21) Appl. No.: 19/064,978

(22) Filed: Feb. 27, 2025

(30) Foreign Application Priority Data
Mar. 15, 2024 (JP) 2024-041670

(51) Int. Cl. G06V 10/62; G06V 40/20

(52) U.S. Cl. CPC G06V 10/62; G06V 40/23

(57) ABSTRACT

An information processing apparatus according to an embodiment is capable of detecting whether or not there is a temporal difference between a first operation and a second operation different from the first operation based on presence or absence of a frame included in only either first time-series data related to the first operation and second time-series data related to the second operation, the first time-series data and the second time-series data being associated in units of time-series frames.

### CROSS-REFERENCE TO RELATED APPLICATION

This application is based upon and claims the benefit of priority from Japanese Patent Application No. 2024-041670, filed Mar. 15, 2024, the entire contents of which are incorporated herein by reference.

### FIELD

Embodiments of the present invention relate generally to an information processing apparatus and a detection method.

### BACKGROUND

In recent years, there has been a technique of analyzing work of a worker from captured data from a camera and skeleton position information of a person acquired by a person posture detector or a motion sensor, which has attracted attention. Further, for example, there has been a demand for a technique of efficiently indicating, to a beginner or a person with little work experience, the relationship between the content of the own work operation of the beginner or the person with little work experience and the work operation of a skilled worker through images by using this work analysis.

### DESCRIPTION OF THE DRAWINGS

FIG. 1 is a schematic diagram illustrating an example of a configuration of an information processing system in a first embodiment.

FIG. 2 is a schematic diagram illustrating another example of the configuration of the information processing system in the first embodiment.

FIG. 3 is a schematic diagram illustrating an example of a configuration of an information processing system in the first embodiment.

FIG. 4 is a diagram illustrating an example of joint position extraction according to an embodiment.

FIG. 5 is an example of an association graph obtained by a DTW method.

FIG. 6 is another example of the association graph obtained by the DTW method.

FIG. 7 is an example of a display unit in the first embodiment.

FIG. 8 is a schematic diagram of an example of an information processing system in a first modification.

FIG. 9 is a schematic diagram of an example of an information processing system in a second modification.

FIG. 10 is an example of an association graph represented by a line graph.

FIG. 11 is an example of a display image of a display unit in a second embodiment.

FIG. 12 is an example of a display image of a display unit in a third embodiment.

FIG. 13 is an example of an association graph in a fourth embodiment.

FIG. 14 is another example of the association graph in the fourth embodiment.

FIG. 15 is a schematic diagram of an example of an information processing system in a seventh embodiment.

FIG. 16 is a schematic diagram of an example of an information processing system in an eighth embodiment.

### DETAILED DESCRIPTION

According to an embodiment, an information processing apparatus is capable of detecting whether or not there is a temporal difference between a first operation and a second operation different from the first operation based on presence or absence of a frame included in only either first time-series data related to the first operation or second time-series data related to the second operation, the first time-series data and the second time-series data being associated in units of time-series frames.

Hereinafter, embodiments will be described with reference to the accompanying drawings. In each embodiment, substantially the same constituent parts are denoted by the same reference signs, and the description thereof may be partially omitted. The drawings are schematic, and the relationship between the thickness and the planar dimensions of each part, the ratio of the thickness of each part, and the like may be different from actual ones.

### First Embodiment

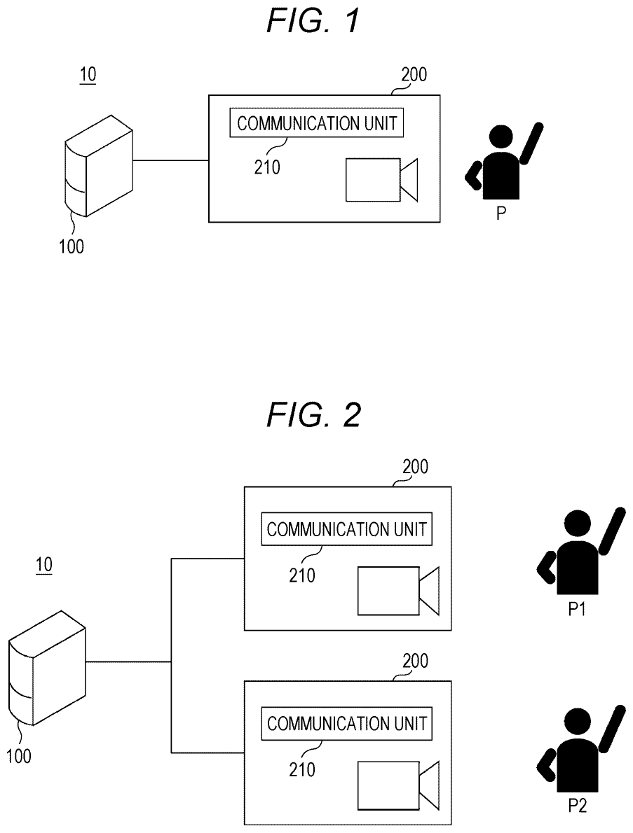

FIG. 1 is a schematic diagram illustrating an example of a configuration of an information processing system 10 in the present embodiment. The information processing system includes an information acquisition terminal 200 and an information apparatus 100. The information acquisition terminal 200 and the information processing apparatus 100 are communicatively connected to each other via a network. As the network, various communication networks such as the Internet can be adopted regardless of whether the network is wired or wireless.

The information acquisition terminal 200 is a terminal that acquires an operation of worker P (including P1 and P2). The information acquisition terminal 200 may be a mobile terminal such as a smartphone or a tablet PC, a stationary terminal, a terminal installed on a site of a factory or a business place, or the like. The information acquisition terminal 200 has a camera function of capturing the operation of the worker P, or is connected to a camera device and captures the operation of the worker P. Alternatively, the information acquisition terminal 200 has a sensor function of detecting the operation of the worker P, is connected to a sensor device, and detects the operation of the worker P. A capturing and detection target range of the operation is not limited to the entire body of the worker P, and may be a part thereof such as the upper body and only the hand. Furthermore, the same operation of the worker P is captured by a plurality of information acquisition terminals 200 while changing the angle, so that it is possible to perform more detailed analysis and issue correction instruction of an operation difference. In addition, the information acquisition terminal 200 is not necessarily a terminal owned by the worker P, and may be, for example, a terminal owned by a service provider that provides a skill acquisition service. The information acquisition terminal 200 can capture and/or detect operations of a worker P (described as a “proficient worker P1” below) accustomed to work and a worker P (described as a “beginner P2” below) unaccustomed to the work. Hereinafter, the description will be given about “capturing of the operation” including capturing of the operation of the worker P by a camera and detection by a sensor. In the information processing system, the information acquisition terminal 200 that captures the proficient worker P1 and a terminal that captures the beginner P2 may be the same terminal, or as illustrated in FIG. 2, the information processing system may include a plurality of information acquisition terminals 200, and the information acquisition terminal 200 that captures the proficient worker P1 and the information acquisition terminal 200 that captures the beginner P2 may be different terminals.

The information acquisition terminal 200 includes a communication unit 210 that communicates with the information processing apparatus 100. The communication unit 210 is realized by, for example, a network interface card (NIC) or the like.

The information processing apparatus 100 analyzes a work difference between the proficient worker P1 and the beginner P2 based on the operation of the worker acquired by the information acquisition terminal 200.

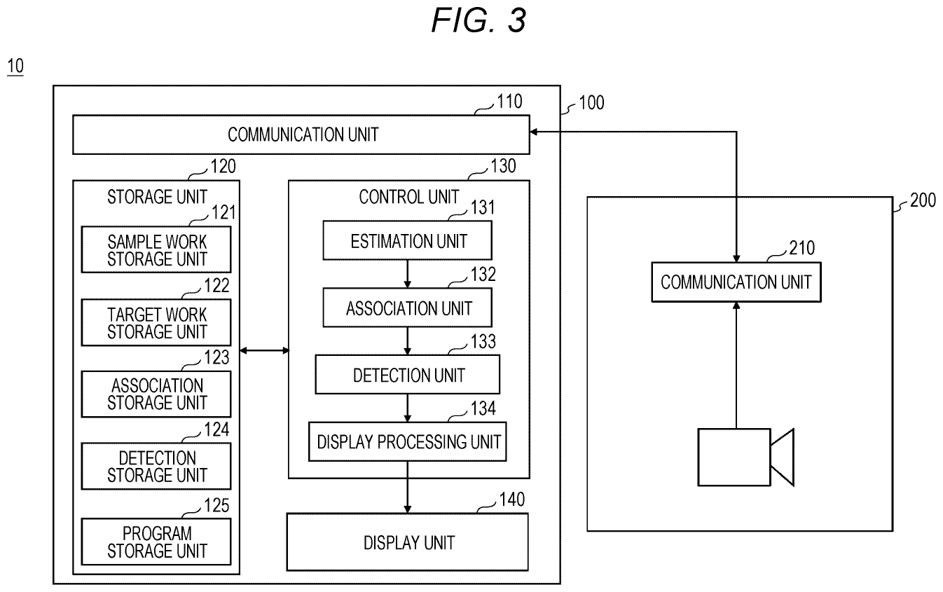

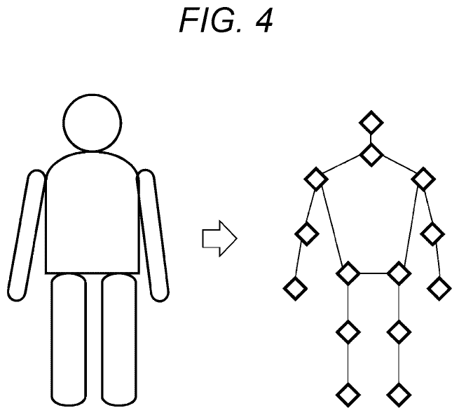

FIG. 3 is a schematic diagram illustrating an example of a configuration of the information processing apparatus 100 in the present embodiment. The information processing apparatus 100 can detect whether or not there is a temporal difference between a first operation and a second operation different from the first operation based on the presence or absence of a frame included in only either first time-series data related to the first operation and second time-series data related to the second operation. The first time-series data and the second time-series data are associated in units of time-series frames. Specifically, the information processing apparatus 100 includes: an association unit 132 that associates a frame included in data including a time series in which a first operation (here, sample work) of a first operation subject (here, the proficient worker P1) is recorded with a frame included in data including a time series in which a second operation (here, target work) of a second operation subject (here, the beginner P2) is recorded; and a detection unit 133 that detects a difference in progress between the first operation and the second operation based on the presence or absence of a frame included in only either the data including the time series in which the first operation is recorded or the data including the time series in which the second operation is recorded. The difference in progress is caused, for example, by a case where one worker skips a work process and proceeds too much, or a case when the worker is inexperienced in the work and causes a delay. The sample work (first operation) is an operation used as a sample when the beginner P2 (second operation subject) performs target work (second operation).

Here, the frame is one frame of a still image constituting a moving image in which the operation of the proficient worker P1 or the beginner P2 is recorded. However, the moving image here is not limited to the initial raw data captured, and is assumed to include the processed moving image and a series of data obtained by extracting skeleton coordinates and the like of a subject from a moving image.

The information processing apparatus 100 is, for example, a server apparatus that performs work difference analysis. The information processing apparatus 100 includes a communication unit 110, a storage unit 120, a control unit 130, and a display unit 140.

The communication unit 110 is realized by, for example, a network interface card (NIC) or the like. The information processing apparatus 100 is connected to the information acquisition terminal 200 in a wired or wireless manner, and transmits and receives information to and from the information acquisition terminal 200 via the communication unit 110. The information transmitted and received here is information regarding the operation of the worker P (including the proficient worker P1 and the beginner P2) acquired by the information acquisition terminal 200, information regarding control of the information acquisition terminal 200, and the like. The information regarding the operation of the worker P includes a moving image showing a series of operations of the worker P, data including a series of movements of the worker P captured by the information acquisition terminal 200 as a sensor, and the like. The information regarding the control of the information acquisition terminal 200 includes control of ON/OFF of the information acquisition terminal 200, control information of parameters such as a moving image frame rate, image quality, and brightness at the time of recording, and the like.

The storage unit 120 is realized by, for example, a semiconductor memory element such as a random access memory (RAM) or a flash memory, or a storage device such as a hard disk or an optical disc. The storage unit 120 stores data along the time series of the posture coordinates of the proficient worker P1 included in the time-series data in which the sample work is recorded, data along the time series of posture coordinates of the beginner P2 included in the time-series data in which the target work is recorded, various programs to be executed by the control unit 130, and various types of data output by the control unit 130. Here, the “posture coordinates” are data indicating the posture of the worker P in quantified coordinates. As illustrated in FIG. 3, the storage unit 120 includes a sample work storage unit 121, a target work storage unit 122, an association storage unit 123, a detection storage unit 124, and a program storage unit 125. Hereinafter, each storage unit included in the storage unit 120 will be sequentially described.

The sample work storage unit 121 stores the target work as moving image data acquired by the information acquisition terminal 200 or data of posture coordinates representing a posture, along a time series. The target work is, for example, the operation of the proficient worker P1. The data stored in the sample work storage unit 121 is, for example, moving image data obtained by capturing the operation of the proficient worker P1. Alternatively, the data stored in the sample work storage unit 121 may be time-series data of posture coordinates representing position coordinates and a rotation direction of each part of the body of the proficient worker P1, which are acquired by the estimation unit 131 performing skeleton estimation of the proficient worker P1 from the moving image data. As a result, it is possible to reduce the size of data to be handled as compared with the moving image data, and to reduce consumption of various resources.

The target work storage unit 122 stores moving image data acquired by the information acquisition terminal 200 fort target work or data of posture coordinates representing a posture along a time series. The target work is, for example, an operation of the beginner P2. Data stored in the target work storage unit 122 is, for example, moving image data obtained by capturing the operation of the beginner P2. Alternatively, similarly to the data accumulated in the sample work storage unit 121, the data stored in the target work storage unit 122 may be time-series data of posture coordinates representing position coordinates and a rotation direction of each part of the body of the beginner P2, which are acquired by the estimation unit 131 performing skeleton estimation of the beginner P2 from the moving image data. As a result, it is possible to reduce the size of data to be handled as compared with the moving image data, and to reduce consumption of various resources. The format of the data stored in the sample work storage unit 121 and the format of the data stored in the target work storage unit 122 may be the same or different.

A user can designate whether to store the moving image data acquired by the information acquisition terminal 200 and the posture coordinates estimated by the estimation unit 131 in the sample work storage unit 121 or the target work storage unit 122. For example, the sample work storage unit 121 can expect work improvement of the target worker by storing a worker whose work time is shorter than that of the target worker in a certain work process. Alternatively, the determination may be made based on attribute data of the worker P (including the proficient worker P1 and the beginner P2) input in advance. In this case, as the attribute data of the worker P, data obtained by scoring the age, the service years, the qualification held, the work of the worker P, and the like are stored in the storage unit 120. Here, the “scoring” of the work is to quantify the feature amount of the operation of the worker P. As the feature amount, there is a vector output from a machine learning model having joint positions and image information as inputs. Examples of the machine learning model include a convolutional neural network (CNN) and a graph convolutional network (GCN), and the output vector can be expressed in a high dimension such as 512 dimensions. Since there are coordinates representing the position of the joint position, an angle at which the neck is tilted or the elbow is bent, a time during which the hand is placed at a specific position, a speed at which the eye line is moved, a direction of the body, and the like, and each of the position coordinates, the angle, the time, and the speed is the quantifiable feature amount, representative values such as an average, a median, and a mode are calculated. In a case where the attribute data exceeds a predetermined evaluation value, the worker P may be treated as the proficient worker P1, the moving image data and the posture coordinates of the worker P may be stored in the sample work storage unit 121. In a case where the attribute data is equal to or less than the predetermined evaluation value, the worker P may be treated as the beginner P2, and the moving image and the posture coordinates of the worker P may be stored in the target work storage unit 122. Alternatively, the data of the worker P who could finish the work earlier than a predetermined time may be stored in the sample work storage unit 121, and the data of the worker P who took more time than the predetermined time may be stored in the target work storage unit 122. The reference values of the attribute data and the work time may be fixed values set in advance, a value that changes based on the performance of the worker P, or a value freely set by the user of the information processing system 10.

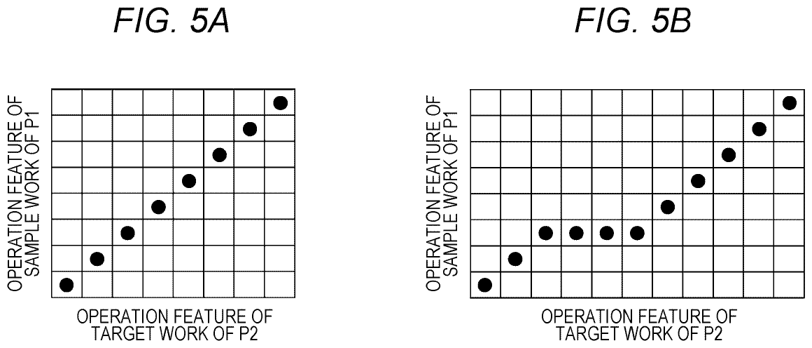

The association storage unit 123 stores a result of associating and outputting the sample work and the target work for each motion by the association unit 132. Here, the “motion” indicates a simple operation included in the sample work and the target work, and is assumed to be represented by, for example, an operation such as raising the hand, changing the direction of the body, and temporarily stopping the operation. Data stored in the association storage unit 123 is, for example, in a graph format such as an association graph (described later with reference to FIG. 5) obtained by the association unit 132. Alternatively, the data may be data in a table format or another format including data corresponding thereto.

The detection storage unit 124 stores data output regarding the temporal difference of the target work detected by the detection unit 133.

The program storage unit 125 stores various programs executed by the control unit 130.

The control unit 130 is a processing unit that controls the entire information processing apparatus, and is, for example, a central processing unit (CPU), a micro processing unit (MPU), or the like (so-called a processor). The control unit 130 loads various programs (for example, an information processing program according to the present application) stored in the storage unit 120 into a RAM as a work area and executes the programs. In addition, the control unit 130 is realized by, for example, an integrated circuit such as an application specific integrated circuit (ASIC) or a field programmable gate array (FPGA).

The control unit 130 includes an estimation unit 131, an association unit 132, and a detection unit 133, and realizes or executes each function and action described below. The internal configuration of the control unit 130 is not limited to the configuration illustrated in FIG. 3, and may be another configuration as long as the configuration performs analysis processing of a difference between the operation of the proficient worker P1 and the operation of the beginner P2 described later. In addition, the connection relationship between the processing units of the control unit 130 is not limited to the connection relationship illustrated in FIG. 3, and another connection relationship may be made.

The estimation unit 131 estimates the posture coordinates of the proficient worker P1 from the time-series data in which the sample work is recorded, and estimates the posture coordinates of the beginner P2 from the time-series data in which the target work is recorded. In addition, the estimated posture coordinates are stored in the storage unit 120. By executing an estimation program stored in the program storage unit 125, the estimation unit 131 specifies each part or joint position of the body of the proficient worker P1 or the beginner P2 by image recognition and image processing from the moving image obtained by capturing the operations of the proficient worker P1 and the beginner P2, and estimates posture coordinates necessary for subsequent processing. FIG. 4 is a diagram illustrating an example of joint position extraction according to the embodiment. An example in which the positions of the respective parts as feature points of the body such as the joint such as the elbow and the knee, the head, and the palm are represented by rhombuses, and the feature points are connected by straight lines will be described. The estimation unit 131 can estimate a skeleton as illustrated from a moving image obtained by capturing the worker P. At this time, the same type of body part and joint position estimated for the proficient worker P1 and the same type of body part and joint position estimated for the beginner P2 are used. A target of estimation of the estimation unit 131 is not limited to the entire body of the proficient worker P1 and the beginner P2, and may focus on a part of the body. For example, it may focus on fine operation of fingers or movement of an eyeball (line of sight).

The association unit 132 associates, for each motion, a frame included in the time-series data in which the sample work is recorded and a frame included in the time-series data in which the target work is recorded, with each other by using dynamic programming. By executing an association program stored in the program storage unit 125, the association unit 132 associates the sample work stored in the sample work storage unit 121 and the data along the time series of the posture coordinates of the target work stored in the target work storage unit 122 for each motion. The association unit 132 outputs, as a graph, a correspondence relationship for each motion between the frame included in the time-series data in which the sample work is recorded and the frame included in the time-series data in which the target work is recorded. FIG. 5 is an example of an association graph obtained by a dynamic time warping (DTW) method of dynamic programming used for time association. In the association graph illustrated in FIG. 5, the vertical axis represents the progress of the sample work along the time series of the sample work of the proficient worker P1, and the horizontal axis represents the progress of the target work along the time series of the target work of the beginner P2. Black dots in the association graph indicate points corresponding to the movement of each work. The association graph illustrated in FIG. 5A is an association graph in a case where the beginner P2 improves and can work at the same pace as the proficient worker P1. At this time, since the movement of the beginner P2 is not delayed from the proficient worker P1, the progress of the sample work of the proficient worker P1 and the progress of the target work of the beginner P2 coincide with each other at each time point. On the other hand, the association graph illustrated in FIG. 5B is an association graph in a case where the beginner P2 is delayed from the proficient worker P1. The portion where the black dots are aligned horizontally as in the third to sixth lines from the left represents that the target work performed by the beginner P2 requires more time than that for the sample work performed by the proficient worker P1. This means that the beginner P2 makes useless motion during this time. The illustrated association graph is a discrete graph using dots, but may be expressed by a continuous line graph, a curve, or the like.

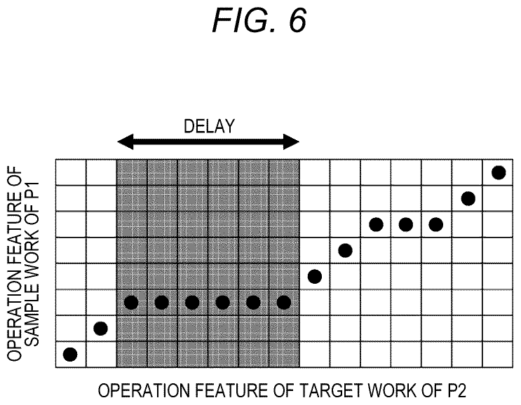

The detection unit 133 detects a portion where the target work is delayed from the sample work, by using the association graph obtained by the association unit 132. The detection unit 133 scans a fixed window in the graph, compares a value indicating a graph inclination in the fixed window with a threshold value, and detects a portion where a temporal difference has occurred. In particular, a portion where the inclination of the graph in the fixed window is equal to or less than a predetermined value is detected as a portion where the second operation is delayed from the first operation. Specifically, as illustrated in FIG. 5B and FIG. 6, it is assumed that a delay of a predetermined level or more is detected as a delay of the beginner P2 among portions where black dots are arranged side by side, and even if a delay occurs instantaneously, the delay is not the delay of the beginner P2 when the delay is equal to or less than a threshold value. The threshold value as to whether or not to detect the delay as the delay of the beginner P2 may be set as the number of black dots arranged side by side or may be based on the time. In FIG. 6, in a case where a time when four or more black dots arranged side by side are continuous is set as the delay of the beginner P2, a portion detected as the delay is illustrated in gray. In FIG. 6, a portion where six black dots are arranged side by side as in the third to eighth columns from the left is detected as “delay”, but a portion where three black dots are arranged side by side as in the eleventh to thirteenth columns from the left is not detected as the delay of the beginner P2. The threshold value as to whether or not to detect the delay may be set in advance, or the user may set any threshold value.

The display processing unit 134 performs processing of causing the display unit 140 to simultaneously display a frame included in the time-series data in which the sample work is recorded and a frame included in the time-series data in which the target work is recorded, the frames being associated with each other in the association unit 132. The display processing unit 134 determines information to be displayed on the display unit 140 by using the result of the delay detected by the detection unit 133. The display processing unit 134 adjusts the reproduction speed of a sample work video and a target work video based on the association graph and the result of the detection unit 133, such that the display unit 140 simultaneously displays the same work. When displaying a frame included in only either the time-series data in which the sample work is recorded or the time-series data in which the target work is recorded, the display processing unit 134 performs processing of stopping the other frame and causing the display unit 140 to display the other frame. Specifically, when black circles are arranged side by side in the association graph, that is, while the beginner P2 performs useless movement, the reproduction speeds of the two videos are determined so that the movement of the proficient worker P1 stops. When the work of the beginner P2 follows the work of the proficient worker P1, the stop of the sample work video is released.

The display processing unit 134 may perform processing of causing the display unit 140 to display the correspondence relationship for each motion between the frame included in the time-series data in which the sample work is recorded and the frame included in the time-series data in which the target work is recorded.

The display unit 140 feeds back information of the temporal work difference to the user by using, for example, the association graph obtained by the association unit 132 and the result of the delay detected by the detection unit 133. The display unit 140 displays information regarding the temporal difference based on the processing of the display processing unit 134. The display unit 140 is a display capable of displaying an image. The display unit 140 may include buttons and the like for operation around the display unit, or may include a touch panel function that can be operated by the user touching the screen.

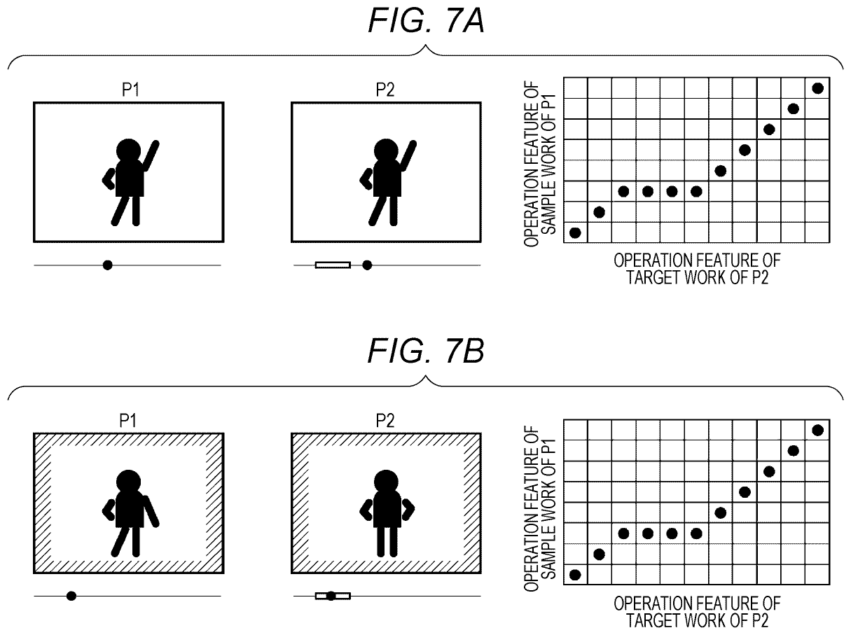

FIG. 7 is an example of the display unit 140 in the present embodiment in a case where the display unit 140 is a screen of a display and displays the analysis result of the work difference as a moving image. A specific example will be described. FIG. 7A is an example of display contents of the display unit 140 that displays information when the proficient worker P1 and the beginner P2 are performing the same work. FIG. 7B is an example of display contents of the display unit 140 that displays information when the beginner P2 is delayed from the proficient worker P1. In the present embodiment, the display unit 140 displays the sample work video and the target work video. In the display unit 140, seek bars are displayed below the sample work video and the target work video, respectively. The user can reproduce the sample work video and the target work video from any position by operating the seek bar. In FIG. 7, a portion corresponding to each motion in the video being reproduced is indicated by a black circle cursor. In addition, in order to recognize the time slot in which the delay of the beginner P2 is detected, the seek bar may display the delay at a position corresponding to the time slot. Specifically, a portion of the seek bar corresponding to the time slot in which the work of the beginner P2 takes time can be thickened or colored. In FIG. 7, the portion of the seek bar corresponding to the time slot in which the beginner P2 is delayed is displayed to be thick with white outline. In addition, in FIG. 7B, the frame of the video is displayed in a highlighted manner while displaying information when the beginner P2 is late for the proficient worker P1. The information displayed on the display unit 140 is not limited to these videos, and a text including an association graph, the number of delay seconds, the number of times, the contents of delayed work, and the like may be displayed. The display unit 140 may be a lamp that indicates the work difference with light, a sound source that indicates the work difference with sound, or the like, in addition to the screen that displays the image. In a case where the display unit 140 is a lamp or a sound source, light or sound may be emitted when a work delay of the beginner P2 is recognized.

In the above embodiment, each piece of data is transmitted and received by the network, and processing of each unit is performed on an edge terminal or a cloud.

Although the example in which the information processing apparatus 100 includes the storage unit 120 and the display unit 140 in addition to the association unit and the detection unit 133 has been described above, the information processing apparatus 100 does not need to include these units. For example, the storage unit 120 may be stored in a server outside the information processing apparatus 100, and may transmit and receive necessary data to and from the external server via the communication unit 110 included in the information processing apparatus 100. Similarly, the display unit 140 is provided outside the information processing apparatus 100, and the information processing apparatus 100 may transmit data of an image to be displayed on the display unit 140 or instruct a timing at which the display unit 140 emits light or sound, via the communication unit 110 included in the information processing apparatus 100 and a communication device (not illustrated) included in the display unit 140.

With the information processing system 10 in the present embodiment, it is possible to analyze the temporal work difference between the proficient worker P1 and the beginner P2 based on the data of the posture coordinates of the proficient worker P1 and the beginner P2 along the time series, and feed back the work difference to the user.

### (First Modification)

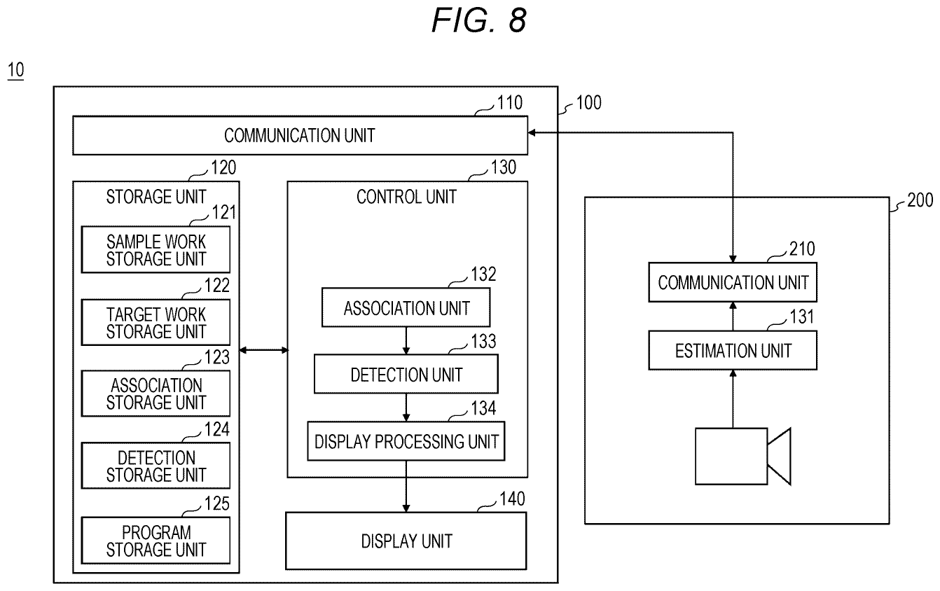

FIG. 8 is a schematic diagram of an example of an information processing system 10 in the present modification. In FIG. 3, it has been described that the estimation unit 131 is included in the information processing apparatus 100, but as illustrated in FIG. 8, the estimation unit 131 may be included in the information acquisition terminal 200. In the information acquisition terminal 200, the posture coordinates of the proficient worker P1 and the beginner P2 are estimated from the images captured by the camera, and the result is transmitted from the communication unit 210 included in the information acquisition terminal 200 to the communication unit 110 included in the information processing apparatus 100, whereby it is possible to reduce the data volume transmitted and received between the communication units as compared with a case where the data of the captured moving image is transmitted as it is.

### (Second Modification)

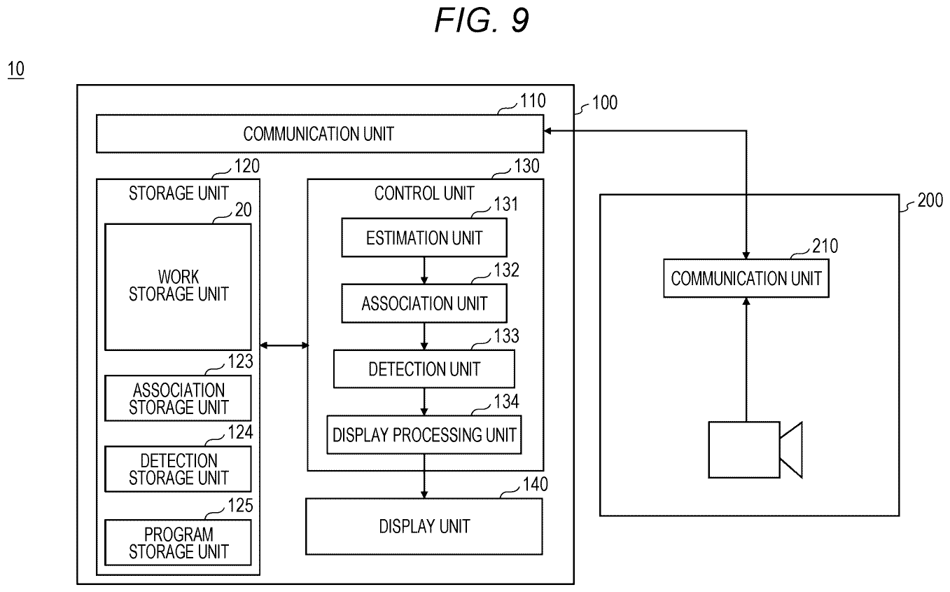

FIG. 9 is a schematic diagram of an example of an information processing system 10 in the present modification. In FIG. 3, the case where the sample work storage unit 121 and the target work storage unit 122 are different has been described. However, as illustrated in FIG. 9, the moving image data and the posture coordinates of the worker P may be collectively stored in the work storage unit 122 without separating the sample work storage unit 121 and the target work storage unit 20.

In the present modification, the user can freely select who is set as the proficient worker P1 among a plurality of workers P, and the proficient worker P1 may be automatically determined based on attribute data of the worker P. In this case, as the attribute data of the worker P, data obtained by scoring the age, the service years, the qualification held, the work of the worker P, and the like are stored in the storage unit 120. The two pieces of attribute data for comparing the work difference are compared. For example, a person who is an aged person can be determined as the proficient worker P1, and can be used for the subsequent processing in the association unit 132, the detection unit 133, and the display unit 140.

### Third Modification

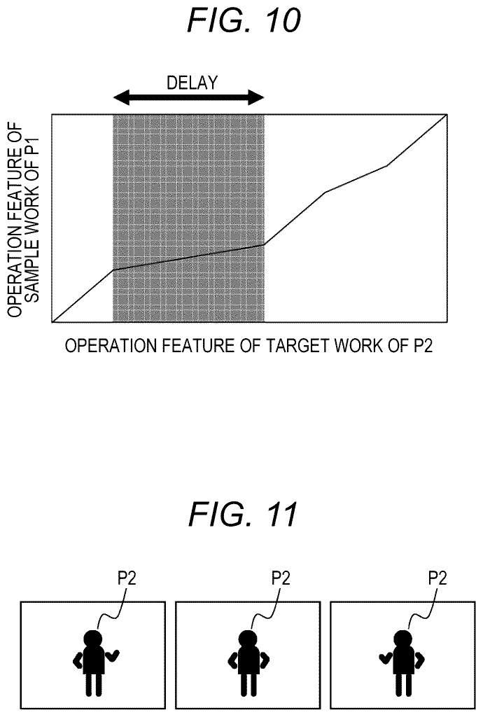

FIG. 10 is an association graph represented by a line graph. In a case where a line graph is used as the association graph in this manner, the delay of the target work of the beginner P2 may be determined based on the inclination of the graph. Specifically, it is determined that the target work of the beginner P2 is delayed in a section in which the inclination of the graph falls below a predetermined threshold value. This threshold value may be set in advance or may be settable by the user. In addition, the determination that the target work of the beginner P2 is delayed is not limited to the case where the inclination of the graph is “less than” the threshold value, and may be set to determine that the target work is delayed when the inclination of the graph is the threshold value “or less”. In FIG. 10, a section in which the beginner P2 is determined to be delayed is indicated in gray.

### Second Embodiment

In the present embodiment, an embodiment common to the first embodiment will be omitted, and only portions different from the first embodiment will be described. In addition, the same names and reference signs as those of the first embodiment will be used for description.

FIG. 11 is an example of a display image of the display unit t 140 in the present embodiment. In the present embodiment, the display unit 140 displays an image when the target work of the beginner P2 is delayed, instead of the moving images of the proficient worker P1 and the beginner P2. The display unit 140 displays a still image selected from frames included in only either the time-series data in which the sample work is recorded or the time-series data in which the target work is recorded. The image displayed here is a representative frame. The representative frame is a frame located at the center of frames corresponding to a section in which the beginner P2 is delayed, the section being detected by the detection unit 133, a frame when the beginner P2 starts to be delayed, or the like, and is selected by the display processing unit 134. Which frame among the frames constituting the moving image when the beginner P2 is delayed is set as the representative frame may be set in advance, or may be set and changed by the user. The number of representative frames is not limited to one, and a plurality of representative frames may be selected. FIG. 11 illustrates a case where three images are displayed on the display unit 140 as representative frames. In the drawing, a frame located at the center of frames corresponding to a section in which the beginner P2 is delayed can be displayed as a representative frame at the center of the screen, a frame of one second before the frame can be displayed on the left, and a frame of one second after the representative frame can be displayed on the right. As a result, the movement for one second before and after the time-requiring work by the beginner P2 can be recognized, and it is possible to clearly recognize the cause of the increase in the required time. By displaying only the representative frame selected by the display processing unit 134 instead of displaying a series of moving images on the display unit 140, it is possible to shorten the time required for feeding back the delay of the beginner P2 to the user.

### Third Embodiment

In the present embodiment, an embodiment common to the first and second embodiments will be omitted, and only portions different from the first and second embodiments will be described. In addition, the same names and reference signs as those of the first and second embodiments will be used for description.

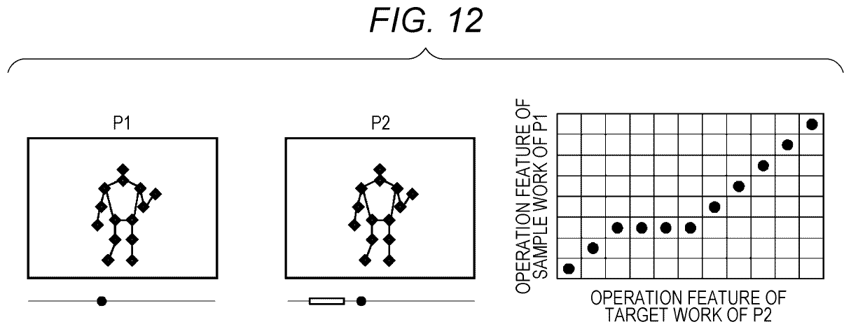

FIG. 12 is an example of a display image of the display unit 140 in the present embodiment. In the present embodiment, the display unit 140 displays a schematic diagram in which the joint positions of the proficient worker P1 and the beginner P2 are linked with lines, an avatar, or the like, instead of the moving image showing the proficient worker P1 and the beginner P2. The display unit 140 displays the sample work in a schematic form of only the skeleton of the proficient worker P1, and displays the target work in a schematic form of only the skeleton of the beginner P2. The display processing unit 134 can generate avatars of the proficient worker P1 and the beginner P2 based on the posture coordinates and the joint positions estimated by the estimation unit 131. Alternatively, as illustrated in FIG. 12, a rough schematic view of the proficient worker P1 and the beginner P2, the rough schematic view being simpler than the avatar, and include points and straight lines representing joint positions. By displaying the avatars on the display unit 140 instead of the moving images showing the proficient worker P1 and the beginner P2, the user can obtain feedback regarding the delay of the beginner P2 while protecting the privacy of the proficient worker P1 and the beginner P2.

### Fourth Embodiment

In the present embodiment, an embodiment common to the first to third embodiments will be omitted, and only portions different from the first to third embodiments will be described. In addition, the same names and reference signs as those of the first to third embodiments will be used for description.

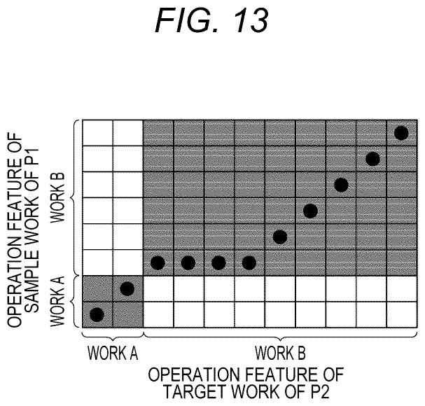

In the present embodiment, the association unit 132 decomposes the sample work and the target work into a first section related to the temporally preceding work and a second section related to the work after the first section, associates a frame included in the first section in the time-series data in which the sample work is recorded with a frame included in the first section in the time-series data in which the target work is recorded, and associates a frame included in the second section in the time-series data in which the sample work is recorded with a frame included in the second section in the time-series data in which the target work is recorded. FIG. 13 is an example of an association graph in the present embodiment. In the association unit 132, the sample work of the proficient worker P1 and the target work of the beginner P2 are decomposed for each work content. FIG. 13 illustrates a case where the proficient worker P1 and the beginner P2 perform work B after work A. The association unit 132 associates the work A of the proficient worker P1 with the work A of the beginner P2, and associates the work B of the proficient worker P1 and the work B of the beginner P2 separately from the work A. The work content may be decomposed in a manner that the user gives an instruction to divide the work content at any portion based on information obtained in advance regarding the work content, or the movement of the worker P may be determined and decomposed by the information processing apparatus 100. By decomposing the work for each work content and performing association for each motion as described above, it is possible to increase the accuracy of association, and furthermore, to reduce the amount of calculation when association using dynamic programming such as the DTW method is performed.

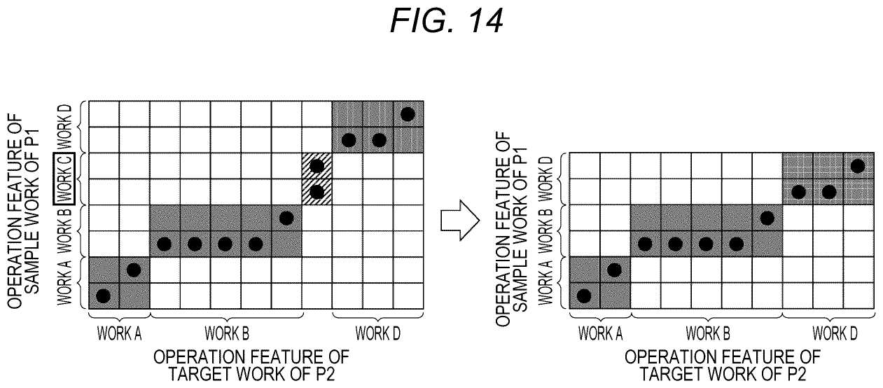

FIG. 14 is another example of the association graph in the present embodiment. The proficient worker P1 performs work A, B, C, and D, and the beginner P2 performs work A, B, and D. At this time, a series of operations is decomposed for each corresponding work, and the association unit 132 performs association by skipping the work C that is not performed by the beginner P2. Such a situation may occur, for example, in a case where the proficient worker P1 can additionally perform advanced work with contrivance of one labor and time, but the beginner P2 performs only necessary and sufficient work. When the association unit 132 performs the association without skipping the work C, the detection unit 133 determines that the proficient worker P1 is delayed from the beginner P2 by the work C. Thus, noise different from a process originally desired to be detected is included in the feedback to the user. Therefore, it is possible to obtain a more accurate work difference analysis result by performing the work difference analysis only for the work common to the proficient worker P1 and the beginner P2.

### Fifth Embodiment

In the present embodiment, an embodiment common to the first to fourth embodiments will be omitted, and only portions different from the first to fourth embodiments will be described. In addition, the same names and reference signs as those of the first to fourth embodiments will be used for description.

In the present embodiment, the work difference analysis can be performed on the target work of the beginner P2 in real time. Here, the real time is not limited to the meaning in a narrow sense that a moment at which the beginner P2 performs a certain operation in the target work and a moment at which the information processing apparatus 100 analyzes and processes this operation are simultaneous, and it is assumed that the real time means that, before the information acquisition terminal 200 ends the measurement of a series of target work of the beginner P2, association of the association unit 132 and detection of whether there is a temporal difference by the detection unit 133 in the information processing apparatus 100 start. Furthermore, the display processing by the display processing unit 134 may be started before the information acquisition terminal 200 ends the measurement of the series of target work of the beginner P2. That is, the recorded data stored in advance is not used as the data of the target work, but the data in which the movement of the beginner P2 is recorded is promptly used as the data of the target work for association in the association unit 132. However, here, description will be given on the assumption that data that has been captured in advance and stored in the sample work storage unit 121 is used for the sample work of the proficient worker P1. Data captured in real time is used for the target work of the beginner P2. A program is executed in the estimation unit 131, the association unit 132, the detection unit 133, and the display processing unit 134 by using these types of data of the sample work and the target work. Although a time lag of several seconds may occur from the actual work of the beginner P2 to the display on the display unit 140 by the time required for each processing, it is possible to reduce the burden of the processing by reducing the frame rate of the video used for analysis, reducing the number of joints of the input posture coordinates, or reducing the search range of association of the dynamic programming (DTW method), thereby shorten the time lag.

As a method of visualizing the result of the real-time work difference analysis, there is a method of displaying, on the display unit 140, a result in which movements of the sample work of the proficient worker P1 and the target work of the beginner P2 are synchronized with each other for each motion. At this time, in order to secure the search range of the DTW method, the data regarding the target work of the beginner P2 input in real time has a buffer so as to store the work in the target work storage unit 122 every predetermined time or every motion. The work of the beginner stored in the target work storage unit 122 as a buffer and the sample work for each predetermined time or for each motion are associated by using the DTW method.

The association unit 132 associates the frame included in the data in which the sample work is recorded with the frame included in the data in which the target work is recorded, for each motion by using the dynamic programming. This point is similar to that of the first embodiment. However, in the present embodiment, data regarding the movement of the beginner P2 acquired in real time is used as the data of the target work. The association unit 132 reads, from the target work storage unit 122, time-series data related to the latest movement of the beginner P2 to some extent (for example, for several seconds), and performs association as the data of the target work. In this state, when time-series data is newly added, the association unit 132 may delete old time-series data from the target work storage unit 122.

The detection unit 133 detects a portion where the target work is delayed from the sample work, by using the association graph obtained by the association unit 132. The time width of the fixed window may be the same as or shorter than the time included in the time-series data read each time from the target work storage unit 122 by the association unit 132.

As described above, by performing the work difference analysis on the target work of the beginner P2 in real time, the beginner P2 can obtain the feedback regarding the difference between the beginner P2 and the proficient worker P1 before forgetting the work performed by the beginner P2.

### Sixth Embodiment

In the present embodiment, an embodiment common to the first to fifth embodiments will be omitted, and only portions different from the first to fifth embodiments will be described. In addition, the same names and reference signs as those of the first to fifth embodiments will be used for description.

In the first to fifth embodiments, it has been described that a person (the proficient worker P1) who performs the sample work and a person (the beginner P2) who performs the target work are different persons. In the present embodiment, the person who performs the sample work and the person who performs the target work can be set to be the same person. A series of operations of the beginner P2 acquired in the past is set as the target work, and a series of operations of the beginner P2 newly acquired is set as the sample work, and the work difference between the target work and the sample work is analyzed. The association unit 132 acquires, from the target work storage unit 122, data obtained when the beginner P2 has worked on the series of the operations for the first time as the target work, and acquires, from the target work storage unit 122, latest data obtained when the beginner P2 has worked on the series of the operations as the sample work. The detection unit 133 detects a portion where the first data of the beginner P2 is delayed from the latest data of the beginner P2.

As described above, the work difference analysis is performed by using the past work as the target work, and using the work of the same person acquired later as the sample work, whereby it is possible to define the skill improvement degree of the same person.

The data selected as the target work in the association unit 132 is not necessarily the first data, and the data selected as the sample work is not necessarily the latest data.

The detection unit 133 may detect a portion where the latest data of the beginner P2 is advanced with respect to the first data of the beginner P2, that is, a portion where the work of the beginner P2 is improved, instead of detecting a portion where the first data of the beginner P2 is delayed from the latest data of the beginner P2.

The operation subject who performs the sample work or the target work is not limited to a person, and may be an animal or a machine such as a robot. Furthermore, the operation subject does not need to move autonomously, and data such as a moving image as a target of the work difference analysis may be data in which the movement of the fluid is recorded, or the like.

### Seventh Embodiment

In the present embodiment, an embodiment common to the first to sixth embodiments will be omitted, and only portions different from the first to sixth embodiments will be described. In addition, the same names and reference signs as those of the first to sixth embodiments will be used for description.

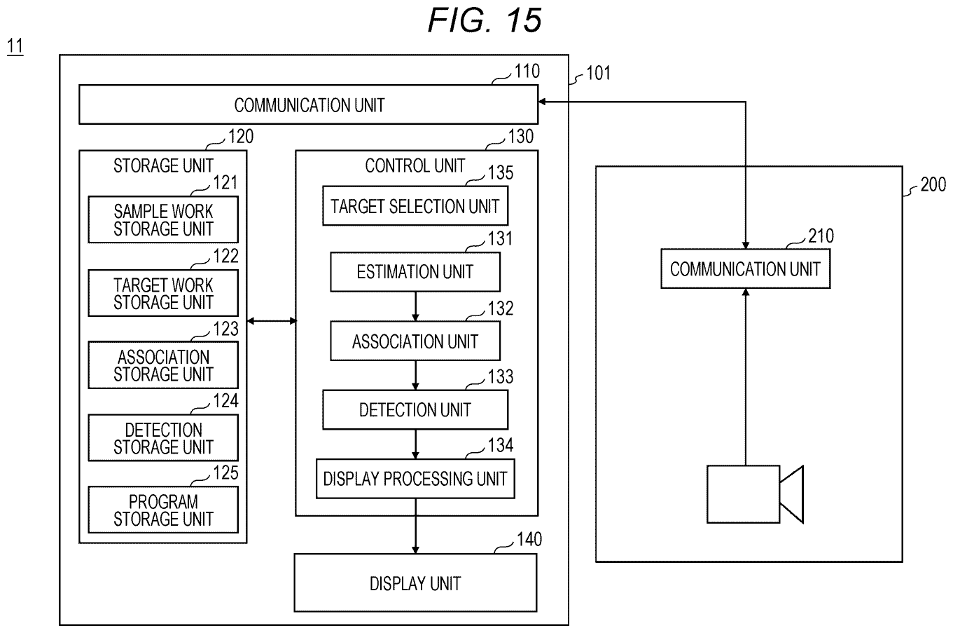

In the present embodiment, a part having low importance in work is excluded from the target of the work difference analysis, and only a part having high importance is selectively set as the target of the work difference analysis. FIG. 15 is a schematic diagram of an example of an information processing system 11 in the present embodiment. An information processing apparatus 101 includes a target selection unit 135 that selects a range as a target for analyzing the difference between the sample work and the target work, from images included in the time-series data in which the sample work is recorded and the time-series data in which the target work is recorded. By executing a target selection program stored in the program storage unit 125, the target selection unit 135 can select the range of the image as the target of the work difference analysis based on, for example, coordinates. The user may designate any range as the range, or the target selection unit 135 may determine the range. When the target selection unit 135 determines the range, a range suitable for the designated work content or the work content determined by the information processing apparatus 101 can be set as the target range of the work difference analysis. For example, in the case of the difference analysis of assembly work on a belt conveyor, the entire body of the worker P is set as the target range, and in the case of the detailed assembly work on a desk, only the hand of the worker P is set as the target range. Alternatively, the target selection unit 135 may determine the target range from the movement of the worker P. For example, in a case where the movement of the lower body is extremely small, the lower body of the worker P can be excluded from the target range. The moving image data and the posture coordinates of the worker P whose target range is limited by the target selection unit 135 are stored in the sample work storage unit 121 and the target work storage unit 122. The following processing in the estimation unit 131 to the display processing unit 134 also uses data with a limited target range.

As described above, by performing the work difference analysis while excluding the part with low importance, it is possible to reduce the amount of use of the storage unit 120 and to improve the speed and accuracy of the analysis.

The target range may be limited by the target selection unit 135 before the processing in the estimation unit 131 or after the processing in the estimation unit 131.

### Eighth Embodiment

In the present embodiment, an embodiment common to the first to seventh embodiments will be omitted, and only portions different from the first to seventh embodiments will be described. In addition, the same names and reference signs as those of the first to seventh embodiments will be used for description.

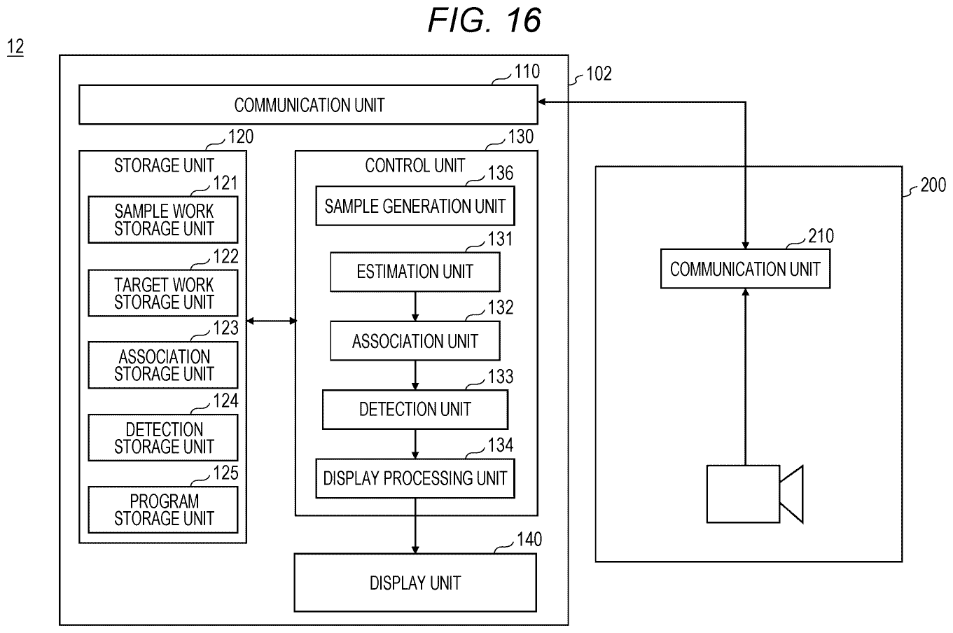

In the present embodiment, the feature amount of the operation of the proficient worker P1 is quantified, and the operation generated based on the representative value of the feature amount is set as the sample work. FIG. 16 is a schematic diagram of an example of an information processing system 12 in the present embodiment. In an information processing apparatus 102, the sample work is generated based on the representative value included in data of the posture coordinates of a plurality of proficient workers P1 along the time series. The information processing apparatus 102 includes a sample generation unit 136. The sample generation unit 136 can generate the sample work by executing a sample generation program stored in the program storage unit 125. Examples of the feature amount of the operation of the proficient worker P1 include coordinates representing the height and position of a hand, an arm, a shoulder, a head, or the like, an angle at which the neck is tilted, a time during which the hand is placed at a specific position, a speed at which the eye line is moved, a direction of the body, an angle of the elbow, and the like. Since each of the position coordinates, the angle, the time, and the speed is a quantifiable feature amount, the representative value such as an average, a median, or a mode can be calculated. Based on the calculated representative value, the sample generation unit 136 generates sample work, and the generated sample work is stored in the sample work storage unit 121. Subsequent processing related to the work difference analysis is also performed by using the generated sample work.

As described above, by generating the sample work based on the representative values of a plurality of pieces of data, even if there is a single mistake, delay, or the like that may occur in the proficient worker P1, outliers of these movements can be reduced.

The persons appearing as the proficient worker P1 in a plurality of moving images input to generate the sample work does not need to be the same person. The same work is generated based on the representative value of a plurality of pieces of data by using different persons as the proficient worker P1, whereby it is possible to perform the work difference analysis by using the sample work in which individual habits are reduced.

### Ninth Embodiment

In the present embodiment, an embodiment common to the first to eighth embodiments will be omitted, and only portions different from the first to eighth embodiments will be described. In addition, the same names and reference signs as those of the first to eighth embodiments will be used for description.

In the present embodiment, the sample work is represented by a CG model. When a program related to the sample work is input, the sample generation unit 136 can generate a CG model as the sample work. By using the data generated from the program as the sample work instead of using the actual human data, it is possible to compare the analysis target with the perfect work without errors.

Although some embodiments have been described above, the present invention is not limited to the above-described embodiments as they are, and the components can be modified and embodied in the implementation stage without departing from the gist thereof. In addition, various inventions can be formed by appropriately combining a plurality of components disclosed in the above embodiments. For example, some components may be deleted from all the components described in the embodiments. Furthermore, the components of different embodiments may be appropriately combined.

Furthermore, the present disclosure includes examples according to the following supplementary notes.

### Supplementary Note 1

An information processing apparatus capable of detecting whether or not there is a temporal difference between a first operation and a second operation different from the first operation based on presence or absence of a frame included in only either first time-series data related to the first operation or second time-series data related to the second operation, the first time-series data and the second time-series data being associated in units of time-series frames.

### Supplementary Note 2

The information processing apparatus according to Supplementary Note 1, further including
a storage unit that stores data of posture coordinates of a first operation subject who performs the first operation in time series, which is included in the first time-series data, and data of posture coordinates of a second operation subject who performs the second operation in time series, which is included in the second time-series data.

### Supplementary Note 3

The information processing apparatus according to Supplementary Note 2, further including
an estimation unit that estimates the posture coordinates of the first operation subject from the first time-series data and estimates the posture coordinates of the second operation subject from the second time-series data, in which
the storage unit stores the posture coordinates.

### Supplementary Note 4

The information processing apparatus according to any one of Supplementary Notes 1 to 3, further including
a display processing unit that executes a process of simultaneously displaying, on a display unit, a frame included in the first time-series data and a frame included in the second time-series data associated with the frame included in the first time-series data.

### Supplementary Note 5

The information processing apparatus according to Supplementary Note 4, in which
when displaying the frame included in only either the first time-series data or the second time-series data, the display processing unit executes a process of stopping an other frame and displaying the other frame on the display unit.

### Supplementary Note 6

The information processing apparatus according to Supplementary Note 1, further including
a display processing unit that executes a process of displaying, on a display unit, a correspondence relationship for each motion between a frame included in the first time-series data and a frame included in the second time-series data.

### Supplementary Note 7

The information processing apparatus according to any one of Supplementary Notes 4 to 6, further including
a display unit that displays information regarding the temporal difference based on the process of the display processing unit.

### Supplementary Note 8

The information processing apparatus according to any one of Supplementary Notes 1 to 7, further including
an association unit that associates a frame included in the first time-series data and a frame included in the second time-series data for each motion by using dynamic programming.

### Supplementary Note 9

The information processing apparatus according to any one of Supplementary Notes 1 to 8, further including:
an association unit that outputs, as a graph, a correspondence relationship for each motion between a frame included in the first time-series data and a frame included in the second time-series data; and
a detection unit that scans a fixed window in the graph, compares a value indicating a graph inclination in the fixed window to a threshold value, and detects a portion where the temporal difference has occurred.

### Supplementary Note 10

The information processing apparatus according to Supplementary Note 9, in which
the association unit outputs the correspondence relationship for each motion between the frame included in the first time-series data and the frame included in the second time-series data as a graph with the first operation on a vertical axis and the second operation on a horizontal axis, and
the detection unit scans a fixed window in the graph and detects a portion where an inclination of the graph in the fixed window is equal to or less than a predetermined value, as a portion where the second operation is delayed from the first operation.

### Supplementary Note 11

The information processing apparatus according to any one of Supplementary Notes 7 to 10, in which
the display unit displays a still image selected from frames included in only either the first time-series data or the second time-series data.

### Supplementary Note 12

The information processing apparatus according to any one of Supplementary Notes 7 to 11, in which
the display unit displays the first operation in a schematic form of only a skeleton of a first operation subject who performs the first operation.

### Supplementary Note 13

The information processing apparatus according to any one of Supplementary Notes 8 to 12, in which
the association unit decomposes the first operation and the second operation into a first section related to temporally preceding work and a second section related to work after the first section,
associates a frame of the first time-series data included in the first section with a frame of the second time-series data included in the first section, and
associates a frame of the first time-series data included in the second section with a frame of the second time-series data included in the second section.

### Supplementary Note 14

The information processing apparatus according to any one of Supplementary Notes 1 to 13, further including
an information acquisition terminal that acquires the second operation, in which
before the information acquisition terminal ends acquisition of a series of second operations, association in units of frames and detection as to whether or not there is the temporal difference are started.

### Supplementary Note 15

The information processing apparatus according to any one of Supplementary Notes 1 to 14, in which
a first operation subject who performs the first operation and a second operation subject who performs the second operation are different from each other.

### Supplementary Note 16

The information processing apparatus according to any one of Supplementary Notes 1 to 15, in which
a first operation subject who performs the first operation and a second operation subject who performs the second operation are a same.

### Supplementary Note 17

The information processing apparatus according to any one of Supplementary Notes 1 to 16, further including
a target selection unit that selects a range in which a difference between the first operation and the second operation is set as an analysis target, from images included in the first time-series data and the second time-series data.

### Supplementary Note 18

The information processing apparatus according to any one of Supplementary Notes 2, 3, 12, 15, and 16, in which
the first operation is generated based on a representative value included in a plurality of pieces of data of posture coordinates of the first operation subject along the time series.

### Supplementary Note 19

The information processing apparatus according to any one of Supplementary Notes 1 to 18, in which
the first operation is represented by a CG model.

### Supplementary Note 20

The information processing apparatus according to any one of Supplementary Notes 1 to 19, in which
the first operation is an operation used as a sample when a second operation subject who performs the second operation performs the second operation.

### Supplementary Note 21

A program for enabling a processing circuit to detect whether or not there is a temporal difference between a first operation and a second operation different from the first operation based on presence or absence of a frame included in only either first time-series data related to the first operation or second time-series data related to the second operation, the first time-series data and the second time-series data being associated in units of time-series frames.

### Supplementary Note 22

A detection method including: by an information processing apparatus, detecting whether or not there is a temporal difference between a first operation and a second operation different from the first operation based on presence or absence of a frame included in only either first time-series data related to the first operation or second time-series data related to the second operation, the first time-series data and the second time-series data being associated in units of time-series frames.

What is claimed is:

1. An information processing apparatus capable of detecting whether or not there is a temporal difference between a first operation and a second operation different from the first operation based on presence or absence of a frame included in only either first time-series data related to the first operation or second time-series data related to the second operation, the first operation and the second operation being associated in units of time-series frames.

2. The information processing apparatus according to claim 1, further comprising
a storage unit that stores data of posture coordinates of a first operation subject who performs the first operation in time series, which is included in the first time-series data, and data of posture coordinates of a second operation subject who performs the second operation in time series, which is included in the second time-series data.

3. The information processing apparatus according to claim 2, further comprising
an estimation unit that estimates the posture coordinates of the first operation subject from the first time-series data and estimates the posture coordinates of the second operation subject from the second time-series data, wherein
the storage unit stores the posture coordinates.

4. The information processing apparatus according to claim 1, further comprising
a display processing unit that executes a process of simultaneously displaying, on a display unit, frame included in the first time-series data and a frame included in the second time-series data associated with the frame included in the first time-series data.

5. The information processing apparatus according to claim 4, wherein
when displaying the frame included in only either the first time-series data or the second time-series data, the display processing unit executes a process of stopping an other frame and displaying the other frame on the display unit.

6. The information processing apparatus according to claim 1, further comprising
a display processing unit that executes a process of displaying, on a display unit, a correspondence relationship for each motion between a frame included in the first time-series data and a frame included in the second time-series data.

7. The information processing apparatus according to claim 4, further comprising
a display unit that displays information regarding the temporal difference based on the process of the display processing unit.

8. The information processing apparatus according to claim 1, further comprising
an association unit that associates a frame included in the first time-series data and a frame included in the second time-series data for each motion by using dynamic programming.

9. The information processing apparatus according to claim 1, further comprising:
an association unit that outputs, as a graph, a correspondence relationship for each motion between a frame included in the first time-series data and a frame included in the second time-series data; and
a detection unit that scans a fixed window in the graph, compares a value indicating a graph inclination in the fixed window to a threshold value, and detects a portion where the temporal difference has occurred.

10. The information processing apparatus according to claim 9, wherein
the association unit outputs the correspondence relationship for each motion between the frame included in the first time-series data and the frame included in the second time-series data as a graph with the first operation on a vertical axis and the second operation on a horizontal axis, and
the detection unit scans a fixed window in the graph and detects a portion where an inclination of the graph in the fixed window is equal to or less than a predetermined value, as a portion where the second operation is delayed from the first operation.

11. The information processing apparatus according to claim 7, wherein
the display unit displays a still image selected from frames included in only either the first time-series data or the second time-series data.

12. The information processing apparatus according to claim 7, wherein
the display unit displays the first operation in a schematic form of only a skeleton of a first operation subject who performs the first operation.

13. The information processing apparatus according to claim 8, wherein
the association unit decomposes the first operation and the second operation into a first section related to temporally preceding work and a second section related to work after the first section,
associates a frame of the first time-series data included in the first section with a frame of the second time-series data included in the first section, and
associates a frame of the first time-series data included in the second section with a frame of the second time-series data included in the second section.

14. The information processing apparatus according to claim 1, further comprising
an information acquisition terminal that acquires the second operation, wherein
before the information acquisition terminal ends acquisition of a series of second operations, association in units of frames and detection as to whether or not there is the temporal difference are started.

15. The information processing apparatus according to claim 1, further comprising
a target selection unit that selects a range in which a difference between the first operation and the second operation is set as an analysis target, from images included in the first time-series data and the second time-series data.

16. The information processing apparatus according to claim 2, wherein
the first operation is generated based on a representative value included in a plurality of pieces of data of posture coordinates of the first operation subject along the time series.

17. The information processing apparatus according to claim 1, wherein
the first operation is an operation used as a sample when a second operation subject who performs the second operation performs the second operation.

18. A detection method comprising: by an information processing apparatus, detecting whether or not there is a temporal difference between a first operation and a second operation different from the first operation based on presence or absence of a frame included in only either first time-series data related to the first operation or second time-series data related to the second operation, the first time-series data and the second time-series data being associated in units of time-series frames.
